(19) United States
(12) Patent Application Publication
(10) Pub. No.: US 2023/0297951 A1
(43) Pub. Date: Sep. 21, 2023

(54) DECISION SUPPORT DEVICE, DECISION SUPPORT SYSTEM, AND DECISION SUPPORT METHOD

(71) Applicant: Hitachi, Ltd., Tokyo (JP)

(72) Inventors: Teppei INOUE, Tokyo (JP); Takahiro OGURA, Tokyo (JP); Mitsuyoshi TSUCHIYA, Tokyo (JP)

(21) Appl. No.: 18/070,822

(22) Filed: Nov. 29, 2022

(30) Foreign Application Priority Data
Mar. 16, 2022 (JP) 2022-041818

(51) Int. Cl. G06Q 10/087; G06Q 10/04; G06Q 30/0283

(52) U.S. Cl. CPC G06Q 10/087; G06Q 10/04; G06Q 30/0283

(57) ABSTRACT

This invention provides a technology to support decision making in doing stock planning across a supply chain. A decision support device disclosed herein comprises a stock deployment plan generating unit which generates a stock deployment plan that becomes optimal throughout a supply chain, an allowable range constraints creating unit which, from multiple participating companies that constitute the supply chain, accepts input of allowable ranges of values of evaluation indices for a set of stock deployment plans, sent by each of the participating companies, and generates constraint information, a unit for attempting to modify stock deployment plans which attempts to modify stock deployment plans using constraint information, a unit for identifying a constraint causing impracticability which identifies constraint information that causes impracticability, if the unit for attempting to modify stock deployment plans fails to obtain a practicable solution, and a unit for requesting reconsideration of allowable range which requests a participating company that has set the constraint information that causes impracticability to input the allowable ranges again.

### BACKGROUND

The present invention relates to a decision support device, a decision support system, and a decision support method.

Japanese Unexamined Patent Application Publication No. 2009-030476 describes a technology about “optimizing operation comprising a constraint condition setting step which sets conditions of constraints, an aspiration level setting step which sets aspiration levels of multiple objective functions, an analysis step which computes a Pareto optimal solution that is as approximate as possible to the aspiration levels under the set conditions of constraints, a Pareto optimal solution displaying step which displays a Pareto optimal solution, a decision step which decides whether the Pareto optimal solution fulfills a predetermined criterion, an aspiration level change setting step which changes the aspiration levels if the Pareto optimal solution does not fulfill the predetermined criterion, an iteration step which iterates the analysis step, the Pareto optimal solution displaying step, and the decision step, and a step of finding the values of manipulated variables proper for the Pareto optimal solution.

### SUMMARY

The technology described in Japanese Unexamined Patent Application Publication No. 2009-030476 cannot be directly applied to a supply chain in which it is required to reflect requests from a certain number of participating companies. Therefore, this technology is also unable to support decision making of the participating companies in doing stock planning across the supply chain that provides parts and services.

The present invention is intended to support decision making in doing stock planning across a supply chain.

In order to solve the above-noted problem, the present application adopts the claimed means, for example. The present invention includes plural means for solving the above-noted problem. One example of such means is a decision support device comprising a stock deployment plan generating unit which generates a stock deployment plan that becomes optimal throughout a supply chain, an allowable range constraints creating unit which, from multiple participating companies that constitute the supply chain, accepts input of allowable ranges of values of evaluation indices for a set of stock deployment plans, sent by each of the participating companies, and generates constraint information, a unit for attempting to modify stock deployment plans which attempts to modify the stock deployment plans using the constraint information, a unit for identifying a constraint causing impracticability which identifies constraint information that causes impracticability, if the unit for attempting to modify stock deployment plans fails to obtain a practicable solution, and a unit for requesting reconsideration of allowable range which requests a participating company that has set the constraint information that causes impracticability to input the allowable ranges again.

According to the present invention, it is possible to support decision making in doing stock planning across a supply chain.

Problems, configurations, and advantageous effects other than noted above will become apparent from the following description of an embodiment.

### BRIEF DESCRIPTION OF THE DRAWINGS

FIG. 1 is a diagram depicting an example of a configuration of a decision support system.

FIG. 2 is a diagram representing an example of a data structure of company information.

FIG. 3 is a diagram representing an example of a data structure of production information.

FIG. 4 is a diagram representing an example of a data structure of transportation information.

FIG. 5 is a diagram representing an example of a data structure of demand information.

FIG. 6 is a diagram representing an example of a data structure of stock information.

FIG. 7 is a diagram representing an example of a data structure of evaluation index prioritizing information.

FIG. 8 is a diagram representing an example of a data structure of stock deployment plan information.

FIG. 9 is a diagram representing an example of a data structure of evaluation index information.

FIG. 10 is a diagram representing an example of a data structure of allowable range information.

FIG. 11 is a diagram representing an example of a data structure of impracticable constraint information.

FIG. 12 is a diagram depicting an example of a hardware configuration of the decision support device.

FIG. 13 is a diagram illustrating an example of a flow of a process to generate stock planning.

FIG. 14 is a diagram illustrating the example of the flow of the process to generate stock planning.

FIG. 15 is a diagram illustrating an example of a screen for accepting ordering of prioritizing the evaluation indices.

FIG. 16 is a diagram illustrating an example of a screen for outputting a stock deployment plan.

FIG. 17 is a diagram illustrating an example of a screen for accepting allowable ranges.

### DETAILED DESCRIPTION

In the following description of an embodiment, the embodiment may be divided into plural sections or sub-embodiments, when necessary for convenience sake, and these sections or sub-embodiments may be described; unless otherwise specified, they are not independent of each other and they relate to one another such that one is an example of modification, detailed description, supplementary description, etc. of another in part or whole.

Besides, in the following description of an embodiment, where mention is made of the number of elements among others (including the number of pieces, a numeric value, a quantity, a range, etc.), that number should not be limited to a particular number mentioned and may be more or less than the particular number, unless otherwise specified and unless that number is, in principle, obviously limited to the particular number.

Furthermore, in the following description of an embodiment, needless to say, its components (including constituent steps or the like) are not always necessary, unless otherwise specified and unless such components are, in principle, considered to be obviously necessary.

Likewise, in the following description of an embodiment, when mention is made of the shape of a component or the like, a positional relation between components, etc., such mention should be construed to include those that are substantially similar or analogous to the shape or the like, unless otherwise specified and unless such mention is, in principle, considered to be obviously exclusive. This is also true for a numeric value and a range mentioned above.

Besides, an identical reference designator is, in principle, assigned to an identical member across all drawings to explain the embodiment and its repeated description is omitted. However, even an identical member may be assigned another different reference designator or name, if it is likely that, in consequence of an environmental change or the like, consistent use of the designator of the member before the change causes confusion. An embodiment of the present invention is described below with the aid of the drawings.

For each of manufactured items of products, a decision support system relevant to the embodiment plans and offers efficient stock deployment of articles of the products. With regard to stock deployment plans thus planned and offered, the decision support system computes and presents evaluation indices (including each index in terms of stock, demand fulfillment rate, and cost) for each of participating companies that constitute a supply chain. Besides, the decision support system decides whether the participating companies agree to a particular one of the stock deployment plans. If agreement is unsuccessful, the decision support system accepts allowable ranges of values of the evaluation indices from each participating company, creates a constraints model, and attempts to modify the stock deployment plans under constraints. If, nevertheless, an agreeable stock deployment plan is not available, the decision support system identifies a constraint that causes this fact and requests a participating company that has set the constraint to reconsider an allowable range.

Note that an “input unit”, an “output unit”, and a “communication unit” in the embodiment described below may be one or more interface devices. The one or more interface devices may be at least one of the following:
One or more I/O (Input/Output) interface devices. An I/O interface device interfaces with at least one of an I/O device and a remote computer for display. An I/O interface device interfacing with a remote computer for display may be a communication interface device. At least one I/O device may be a user interface device, e.g., either of an input device such as a keyboard and a pointing device and an output device such as a display device.
One or more communication interface devices. The one or more communication interface devices may be one or more interface devices of the same type (e.g., one or more NICs (Network Interface Cards)) or communication interface devices of two or more types (e.g., NIC and HBA (Host Bus Adapter)).

Besides, a “memory” in the following description comprises one or more memory devices which are examples of one or more storage devices and may typically be a main storage device. At least one memory device in the memory may be either a volatile memory device or a non-volatile memory device.

Besides, an “external storage device” in the following description may comprise one or more persistent storage devices which are examples of one or more storage devices. A persistent storage device may typically be a non-volatile storage device (e.g., an auxiliary storage device) and, in particular, may be, e.g., HDD (Hard Disk Drive), SSD (Solid State Drive), NVME (Non-Volatile Memory Express) drive, or SCM (Storage Class Memory).

Also, in the following description, a “storage unit” or an “external storage device” may comprise a memory or both a memory and a persistent storage device.

Also, in the following description, a “processing unit” or a “processor” may comprise one or more processor devices. At least one processor device may typically be a microprocessor device such as CPU (Central Processing Unit) and may also be a processor device of another type such as GPU (Graphics Processing Unit). At least one processor device may be either single core or multi-core. At least one processor device may be processor core. At least one processor device may be a processor device in a broad sense like gate array integrated circuits designed by a hardware description language to carry out part or all of processing (e.g., FPGA (Field-Programmable Gate Array), CPLD (Complex Programmable Logic Device) or ASIC (Application Specific Integrated Circuit)).

Besides, a “decision support system” in the following description may be either a system configured with one or more physical computers or a system (e.g., a cloud computing system) implemented with a cluster of physical computing resources (e.g., a cloud infrastructure). An operation that the decision support system “displays” information for display may be displaying information for display on a display device that a computer has or may mean that a computer sends information for display to a computer for display (in the latter case, information for display is displayed by the computer for display).

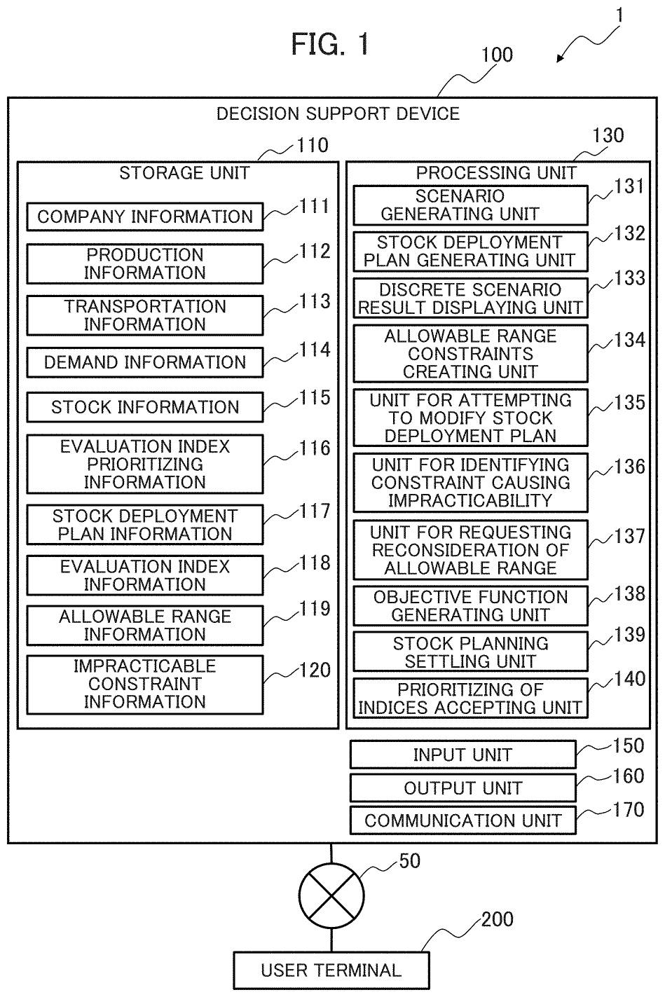

FIG. 1 is a diagram depicting an example of a configuration of a decision support system. The decision support system 1 includes a decision support device 100 and a user terminal 200 that is connected to the decision support device 100 via a network 50 to allow communication with each outer. The decision support system 1 encompasses a group of devices according to usage environment, such as a computer for display, connected via the network 50 to allow communication between them.

The network 50 is any of a communication network, a cellular communication network, etc. or a composite network combining these ones; such network partially or entirely uses general public lines such as, e.g., LAN (Local Area Network), WAN (Wide Area Network), VPN (Virtual Private Network), and the Internet. Additionally, the network may be a wireless communication network such as Wi-Fi (a registered trademark) or 5G (Generation).

The decision support device 100 is a processing device equipped with a storage unit 110, a processing unit 130, an input unit 140, an output unit 160, and a communication unit 170. The storage unit 110 includes information as follows: company information 111, production information 112, transportation information 113, demand information 114, stock information 115, evaluation index prioritizing information 116, stock deployment plan information 117, evaluation index information 118, allowable range information 119, and impracticable constraint information 120.

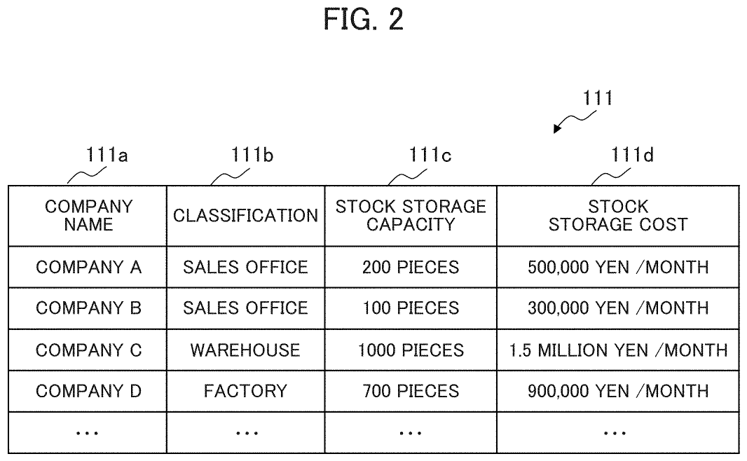

FIG. 2 is a diagram representing an example of a data structure of company information. In the company information 111, information on participating companies constituting a supply chain is listed. The company information 111 is detailed information about stock storage per participating company. In the company information 111, the following attribute data items are stored in a correlated manner: company name 111a that identifies a participating company; classification 111b that specifies a role for a company to take on in the supply chain; stock storage capacity 111c that specifies an upper limit of stock storage capacity of a participating company; and stock storage cost 111d that specifies the cost for stock storage imposed on a participating company.

Classification 111b includes “sales office”, “warehouse”, “factory”, etc. as information specifying a role for a company to take on in the supply chain. For example, “factory” is a role that procures raw materials or parts and manufactures a part or a product and “warehouse” is a role that stocks up raw materials, parts, or products and delivers them in a range of storage.

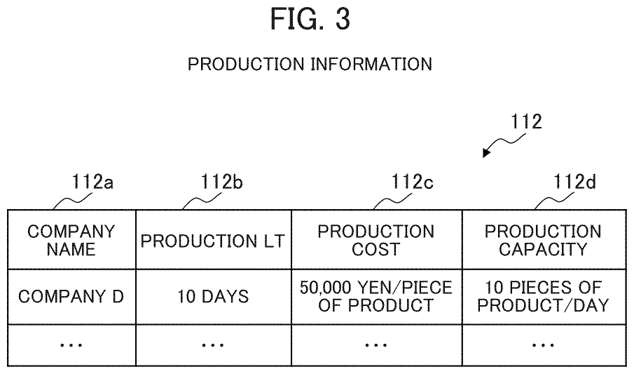

FIG. 3 is a diagram representing an example of a data structure of production information. In the production information 112, participating companies that take on the role of “factory” are listed among the participating companies constituting the supply chain. The production information 112 is detailed information about production capacity per participating company. In the production information 112, the following attribute data items are stored in a correlated manner: company name 112a that identifies a participating company; production LT 112b that specifies a production lead time; production cost 112c that specifies the production cost of a product; and production capacity 112d that is the capacity of producing a product.

For example, a company D of which classification is “factory” and its associated attribute data representing that the production LT for a particular product is 10 days, the cost per piece of the product is 50,000 yen, and the production capacity is 10 pieces of the product per day are stored in a correlated manner in the production information 112.

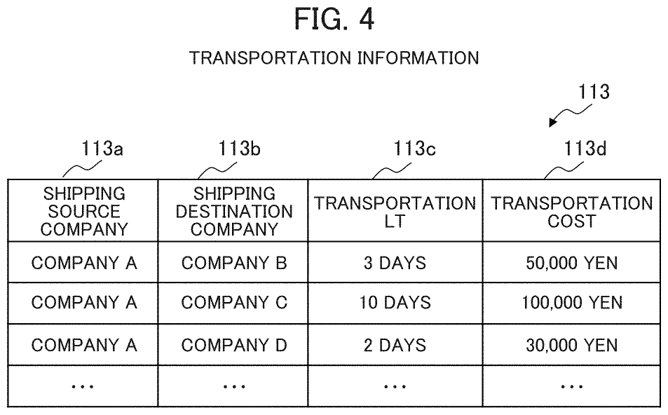

FIG. 4 is a diagram representing an example of a data structure of transportation information. In the transportation information 113, detailed information about transportation between participating companies constituting the supply chain is listed. In the transportation information 113, the following attribute data items are stored in a correlated manner: shipping source company 113a that identifies a participating company as a shipping source; shipping destination company 113b that identifies a participating company as a shipping destination; transportation LT 113c that specifies a transportation lead time; and transportation cost 113d that specifies the cost of transportation.

For example, transportation from “company A” to “company B” and its associated attribute data representing that the transportation LT is 3 days and the transportation cost is 50,000 yen are stored in a correlated manner in the transportation information 113.

In addition, the company information 111, production information 112, and transportation information 113 are illustrated in a simplified form of information necessary to create stock planning across the supply chain, but it goes without saying that more detailed information necessary for stock planning may be included therein.

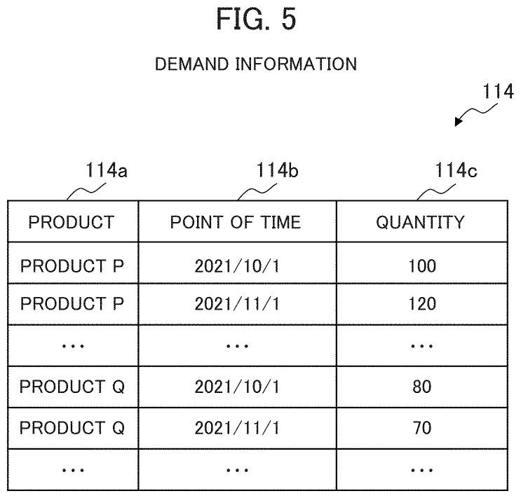

FIG. 5 is a diagram representing an example of a data structure of demand information. The demand information 114 is information including an amount of demand of a product demanded to the supply chain at each certain point of time. In the demand information 114, the following attribute data items are stored in a correlated manner: product 114a; point of time 114b; and quantity 114c.

Point of time 114b is information that specifies a certain point of time or a period. Quantity 114c is information that specifies an amount of demand at the point of time or for the period specified by point of time 114b.

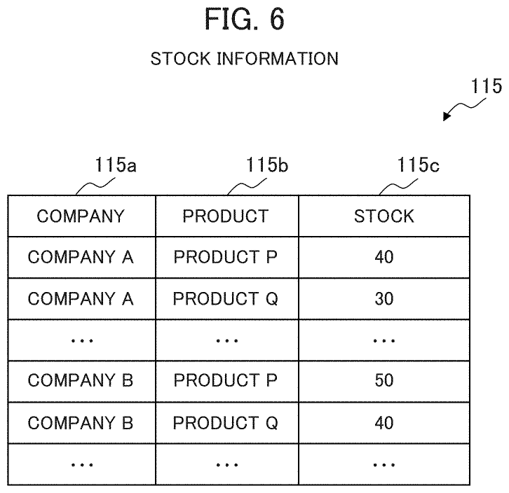

FIG. 6 is a diagram representing an example of a data structure of stock information. The stock information 115 is information including an amount of stock of a product at a point of time of handling in the supply chain. In the stock information 115, the following attribute data items are stored in a correlated manner: company 115a; product 115b; and stock 115c.

Company 115a is information that identifies a participating company. Product 115b is information that identifies a product that is handled by the participating company identified by company 115a. Stock 115c is information that specifies how much stock of the product identified by product 115b.

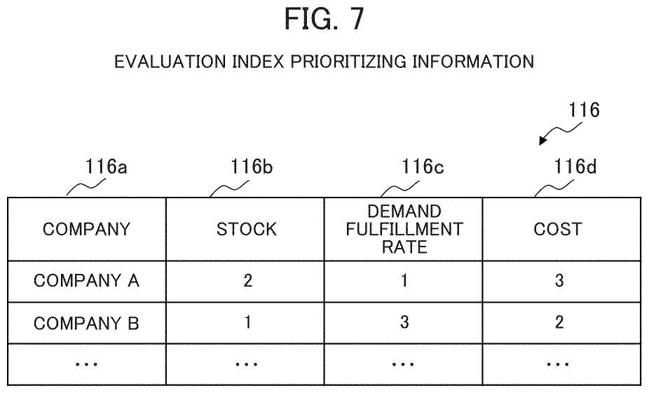

FIG. 7 is a diagram representing an example of a data structure of evaluation index prioritizing information. The evaluation index prioritizing information 16 is information that includes ordering of prioritizing the evaluation indices for each of participating companies constituting the supply chain. In the evaluation index prioritizing information 116, the following attribute data items are stored in a correlated manner: company 116a; stock 116b; demand fulfillment rate 116c; and cost 116d.

Company 116a is information that identifies a participating company. Stock 116b indicates a relative rank of stock that is one of the evaluation indices given in a stock deployment plan of a product that is handled by the participating company identified by company 116a. Demand fulfillment rate 116c indicates a relative rank of demand fulfillment rate that is one of the evaluation indices given in a stock deployment plan of a product that is handled by the participating company identified by company 116a. Cost 116c indicates a relative rank of cost that is one of the evaluation indices given in a stock deployment plan of a product that is handled by the participating company identified by company 116a.

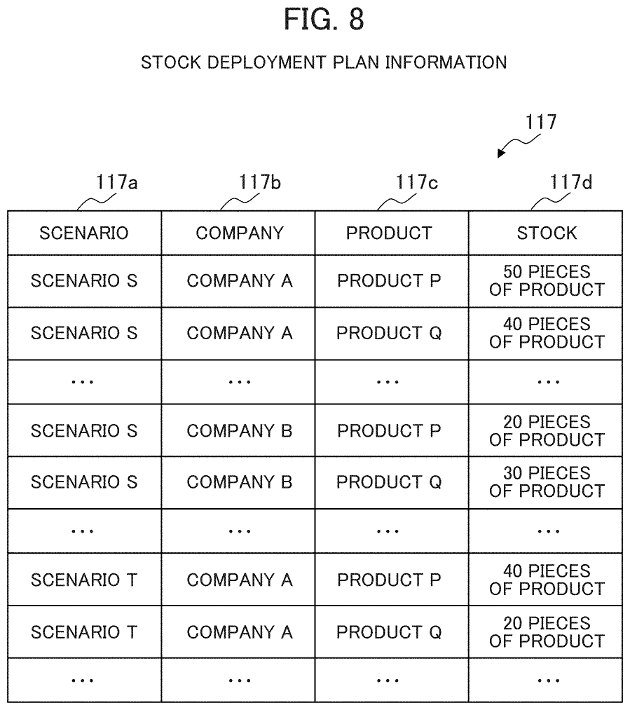

FIG. 8 is a diagram representing an example of a data structure of stock deployment plan information. The stock deployment plan information 117 is information regarding a plan of deploying stocks in the participating companies constituting the supply chain with regard to each of multiple scenarios. In the stock deployment plan information 117, the following attribute data items are stored in a correlated manner: scenario 117a; company 117b; product 117c; and stock 117d.

Scenario 117a is information that distinctively refers to a stock deployment plan across the supply chain created based on setting a criterion to prioritize according to predetermined rules. Company 117b is information that identifies a participating company. Product 117c is information that identifies a product that is handled by the participating company identified by company 117b. Stock 117d is information that specifies how much stock of the product identified by product 115b. Additionally, setting a criterion to prioritize when creating a scenario particularly refers to setting a participating company for which the evaluation indices should be prioritized. The predetermined rules are generating a stock deployment plan with priority given to each of the participating companies and generating a stock deployment plan with priority given to the evaluation indices of the entire supply chain.

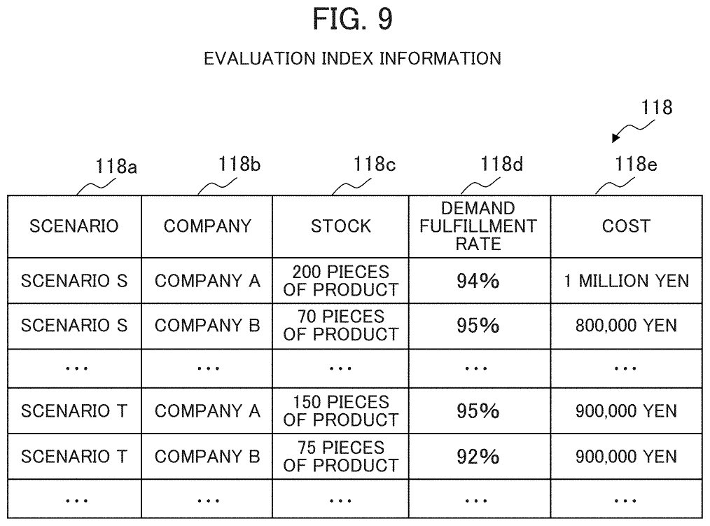

FIG. 9 is a diagram representing an example of a data structure of evaluation index information. The evaluation index information 118 is information that includes ordering of prioritizing the evaluation indices for each of participating companies constituting the supply chain and with respect to each scenario. In the evaluation index information 118, the following attribute data items are stored in a correlated manner: scenario 118a; company 118b; stock 118c; demand fulfillment rate 118d; and cost 118e.

Scenario 118a is information that distinguishes a stock deployment plan across the supply chain created based on setting a criterion to prioritize according to predetermined rules. Company 118b is information that identifies a participating company. Stock 118c indicates a value of stock that is one of the evaluation indices given in a stock deployment plan of a product that is handled by the participating company identified by company 118b. Demand fulfillment rate 118d indicates a value of demand fulfillment rate that is one of the evaluation indices given in a stock deployment plan of a product that is handled by the participating company identified by company 118b. Cost 118e indicates a value of cost that is one of the evaluation indices given in a stock deployment plan of a product that is handled by the participating company identified by company 118b.

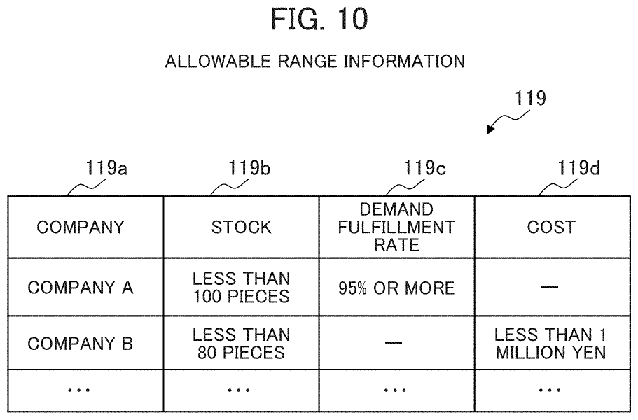

FIG. 10 is a diagram representing an example of a data structure of allowable range information. The allowable range information 119 is information including an allowable range of each of the evaluation indices given in a stock deployment plan with respect of each of the participating companies. In the allowable range information 119, the following attribute data items are stored in a correlated manner: company 119a; stock 119b; demand fulfillment rate 119c; and cost 119d.

Company 119a is information that identifies a participating company. Stock 119b indicates an allowable range of stock that is one of the evaluation indices given in a stock deployment plan of a product that is handled by the participating company identified by company 119a. Demand fulfillment rate 119c indicates an allowable range of demand fulfillment rate that is one of the evaluation indices given in a stock deployment plan of a product that is handled by the participating company identified by company 119a. Cost 119d indicates an allowable range of cost that is one of the evaluation indices given in a stock deployment plan of a product that is handled by the participating company identified by company 119a.

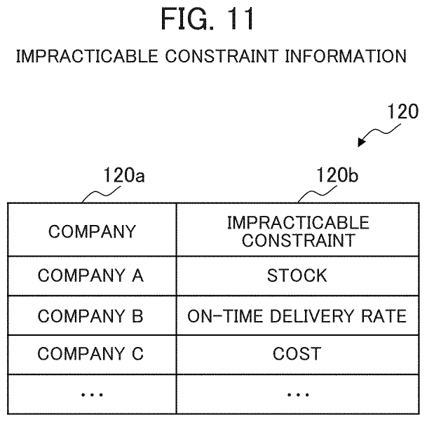

FIG. 11 is a diagram representing an example of a data structure of impracticable constraint information. With respect to a stock deployment plan across the supply chain, if there is no satisfying the allowable range of one of the evaluation indices specified for the participating companies, that is, such plan is regarded as impracticable, the impracticable constraint information 120 includes information that identifies a constraint making it impracticable and a participating company for which the constraint is set. Conversely, with respect to a stock deployment plan, the impracticable constraint information 120 includes a constraint that is assumed to be removed so that the stock deployment plan can be carried out.

Returning to description of FIG. 1, the processing unit 130 includes a scenario generating unit 131, a stock deployment plan generating unit 132, a discrete scenario result displaying unit 133, an allowable range constraints creating unit 134, a unit for attempting to modify stock deployment plans 135, a unit for identifying constraints causing impracticability 136, a unit for requesting reconsideration of allowable range 137, an objective function generating unit 138, a stock planning settling unit 139, and a prioritizing of indices accepting unit 140.

The scenario generating unit 131 sets scenarios in which priority is given to the evaluation indices with respect to any one, any plurality, or any combination of participating companies that constitute the supply chain and generates objective functions to optimize the evaluation indices of the supply chain. An objective function refers to, e.g., a function that is expressed in a mathematical formula (1) below.

[Mathematical Formula 1]

J₁=J_{stock}^{SC}+J_{demand}^{SC}+J_{cost}^{SC}+J_{stock}¹+J_{demand}¹+J_{cost}¹+ . . . +J_{stock}^{N}+J_{demand}^{N}+J_{cost}^{N} (1)

Here, superscripts (SC, 1, . . . N (N is a natural number)) attached to J are symbols, each of which distinctively refers to a participating company to which priority is given. For example, SC is a symbol that denotes the entire supply chain, 1 is a symbol that denotes Company A, and subsequent numbers up to N denotes symbols, each of which denotes each of participating companies that constitute the supply chain. Subscripts (stock, demand, cost) attached to J are symbols that denote stock, demand fulfillment rate, and cost, respectively, as each of the evaluation indices of the supply chain. Therefore, the above formula (1) represents summation of adding the evaluation indices of the entire supply chain to the sum of the evaluation indices of each of the participating companies constituting the supply chain. A stock deployment plan that optimizes this objective function is defined as scenario 1 and other scenarios of 2 and subsequent numbers are defined to be those obtained by giving weight to any one of the participating companies constituting the supply chain without duplication in each scenario.

Note that each term of the above formula (1) may preferably be converted to a value multiplied by a given coefficient or obtained through a given function. This is because directly summing the actual values of, e.g., demand fulfillment rate and cost is nonsense.

The stock deployment plan generating unit 132 generates a stock deployment plan that becomes optimal throughout the supply chain. The stock deployment plan generating unit 132 decides whether a stock deployment plan is optical throughout the supply chain using the above formula (1) as an objective function. In addition to generating such a stock deployment plan that becomes optimal throughout the supply chain, the stock deployment plan generating unit 132 generates stock deployment plans according to a scenario in which priority is given to the evaluation indices of any one or plurality of the participating companies. The stock deployment plan generating unit 132 should generate stock deployment plans using an existing algorithm, but no limitation to this is intended; in an alternative implementation, the decision support device may request another device to generate stock deployment plans and acquire the generated plans via the network 50.

The discrete scenario result displaying unit 133 generates screen information for displaying the evaluation indices in relation to a stock deployment plan across the supply chain according to each scenario.

From multiple participating companies that constitute the supply chain, the allowable range constraints creating unit 134 accepts input of allowable ranges of values of the evaluation indices for a set of stock deployment plans, sent by each of the participating companies, and generates constraint information. Also, the allowable range constraints creating unit 134 generates screen information for accepting input of allowable ranges of values of the evaluation indices for a set of stock deployment plans, sent by each of the multiple participating companies constituting the supply chain.

A mathematical formula (2) below is an example representing allowable range constraints created. This example corresponds to a case where allowable ranges for each company are such that, for Company A, the demand fulfillment rate exceeds 95% and stock is less than 100; for Company B, cost is less than one million yen and stock is less than 80.

[Mathematical Formula 2]

J_{demand}¹>95·%J_{stock}¹<100·J_{cost}²<1MV·J_{stock}²<80 (2)

The unit for attempting to modify stock deployment plans 135 attempts to modify stock deployment plans using constraint information. In particular, the unit for attempting to modify stock deployment plans 135 decides whether a stock deployment plan is optimal throughout the supply chain using the above formula (1) as an objective function. Also, the unit for attempting to modify stock deployment plans 135 performs a simulation with constraint conditions being imposed on the above objective function through the use of constraint information generated by the allowable range constraints creating unit 134 and decides whether or not there is a stock deployment plan that is regarded as a practicable solution.

If the unit for attempting to modify stock deployment plans 135 fails to obtain a practicable solution, the unit for identifying a constraint causing impracticability 136 identifies constraint information that causes impracticability. The unit for identifying a constraint causing impracticability 136 should use an existing algorithm in order to identify constraint information that causes impracticability. However, such an algorithm is simply required to identify one or more pieces of constraint information that is likely to cause impracticability.

The unit for requesting reconsideration of allowable range 137 requests a participating company that has set constraint information that causes impracticability to input an allowable range again. When making a request for re-input, the unit for requesting reconsideration of allowable range 137 displays the evaluation indices per scenario with respect to each of the participating companies concerned. Furthermore, when constraint information causing that a practicable solution cannot be obtained is attributed to contradiction between values of constraints specified as constraint information, the unit for requesting reconsideration of allowable range 137 issues the re-input request to a participating company that has set constraint information that should be removed so that a practicable solution can be obtained, the constraint information corresponding to any of the contradictory values of constraints.

The objective function generating unit 138 generates an objective function for a particular scenario according to order of prioritizing of the evaluation indices with respect to each of the participating companies. A mathematical formula (3) below is an example of an objective function for a scenario N+1 that gives priority to a participating Company N in a case where Company N prioritizes the evaluation indices in order of stock, demand fulfillment rate, and cost.

[Mathematical Formula 3]

J_{N+1}=J_{stock}^{SC}+J_{demand}^{SC}+J_{cost}^{SC}+J_{stock}¹+J_{demand}¹+J_{cost}¹+ . . . +w1*J_{stock}^{N}+w2*J_{demand}^{N}+w3*J_{cost}^{N} (3)

Here, w1, w2, and w3 are weighting factors fulfilling the following relationship: w1>w2>w3>1.

Likewise, a mathematical formula (4) below is an example of an objective function for a scenario 2 that gives priority to a participating Company A in a case where Company A prioritizes the evaluation indices in order of stock, demand fulfillment rate, and cost.

[Mathematical Formula 4]

J₀=J_{stock}^{SC}+J_{demand}^{SC}+J_{cost}^{SC}+w1*J_{stock}¹+w2*J_{demand}¹+w3*J_{cost}¹+ . . . +J_{stock}^{N}+J_{demand}^{N}+J_{cost}^{N} (4)

The stock planning settling unit 139 computes the evaluation indices for a stock deployment plan generated by the stock deployment plan generating unit 132 with respect to each of the participating companies constituting the supply chain, generates and displays screen information for presenting the stock deployment plan and the evaluation indices and accepting input as to whether or not each participant agrees to the stock deployment plan, determines whether agreement from the participating companies is settled, and adopts the stock deployment plan, if agreed, as stock planning.

The prioritizing of indices accepting unit 140 accepts input of prioritizing of the evaluation indices, sent by each of the participating companies.

The input unit 150 receives input information which is, for example, displayed or entered on screen or input by keyboard or mouse operation.

The output unit 160 creates screen information including, e.g., information that is output as a result of execution of a certain process and outputs such information to a computer for a display.

The communication unit 170 performs communication with another device via the network. For example, the communication unit 170 connects with each user terminal 200 that a user mainly uses to enable communication with each other.

The user terminal 200 is equipped with a processing unit, and an input unit, an output unit, and a communication unit

Although not depicted, a Web browser is installed and can be run by the processor to perform communication with the decision support device 100 via the network 50 according to HTTP (HyperText Transfer Protocol) or HTTPS (HyperText Transfer Protocol over Secure Socket Layer).

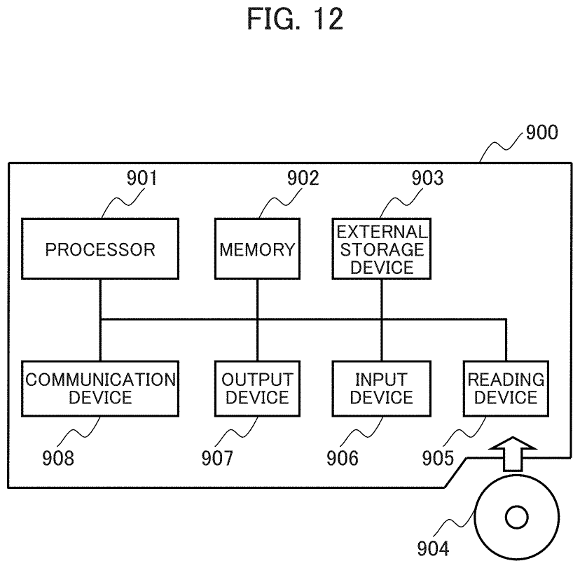

FIG. 12 is a diagram depicting an example of a hardware configuration of the decision support device 100. The decision support device 100 can be implemented by a commonly used computer 900 equipped with a processor (e.g., CPU or GPU) 901, a memory 902 such as RAM (Random Access Memory), an external storage device 903 such as a hard disk device (HDD) or SDD, a reading device 905 that reads information from a portable storage medium 904 such as CD or DVD, an input device 906 including a keyboard, a mouse, a barcode reader, a touch panel, etc., an output device 907 such as a display, and a communication device 908 to communicate with another computer via a communication network, e.g., LAN, the Internet, etc. or by a network system comprising a plurality of such computers 900. Note that, needless to say, the reading device 905 not only reads a portable storage medium 904, may also be capable of writing.

For example, the scenario generating unit 131, the stock deployment plan generating unit 132, the discrete scenario result displaying unit 133, the allowable range constraints creating unit 134, the unit for attempting to modify stock deployment plans 135, the unit for identifying a constraint causing impracticability, the unit for requesting reconsideration of allowable range 137, the objective function generating unit 138, the stock planning settling unit 139, and the prioritizing of indices accepting unit 140 which are included in the processing unit 130 can be implemented in such a way that their predefined programs being stored in the external storage device 903 are loaded into the memory 902 and executed by the processor 901. The input unit 150 can be implemented through use of the input device 906 by the processor 901. The output unit 160 can be implemented through use of the output device 907 or the communication device 908 by the processor 901. The communication unit 170 can be implemented through use of the communication device 908 by the processor 901. The storage unit 110 can be implemented through use of the memory 902 or the external storage device 903 by the processor 901.

The predefined programs may be read from the portable storage medium 904 by the reading device 905 or downloaded from the network by the communication device 908 to the external storage device 903; then, the programs may be loaded into the memory 902 and executed by the processors 901. Alternatively, from the portable storage medium 904 or the network, the programs may be directly loaded into the memory 902 by the reading device 905 or the communication device 908 and executed by the processor 901. Note that hardware implementation of the decision support device 100 is not limited to that described above and may be a wearable computer in the form of, e.g., a headset, goggles, glasses, an intercommunication system, etc.

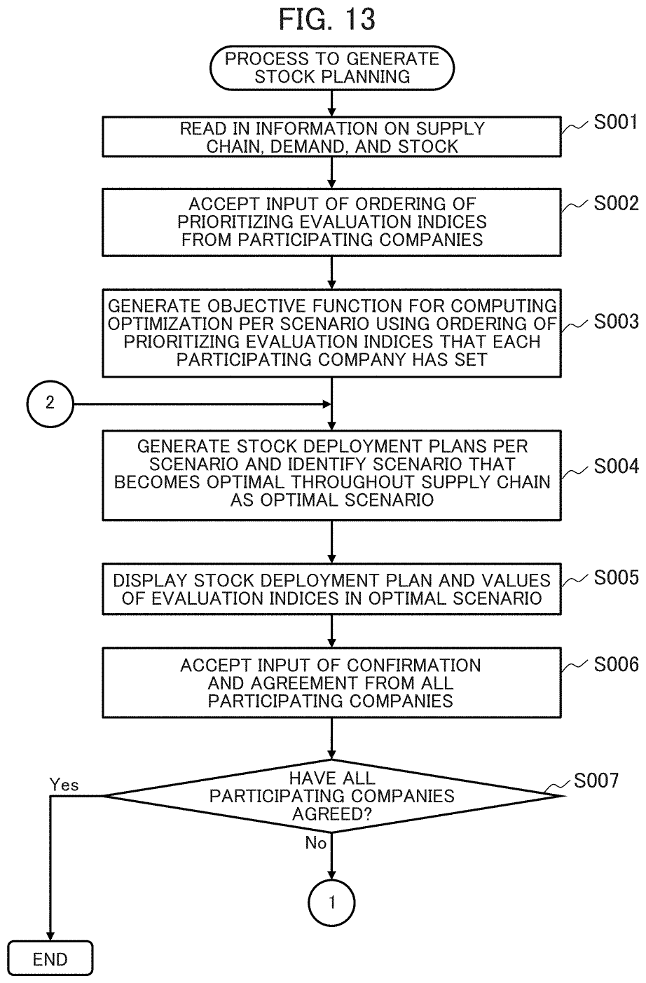

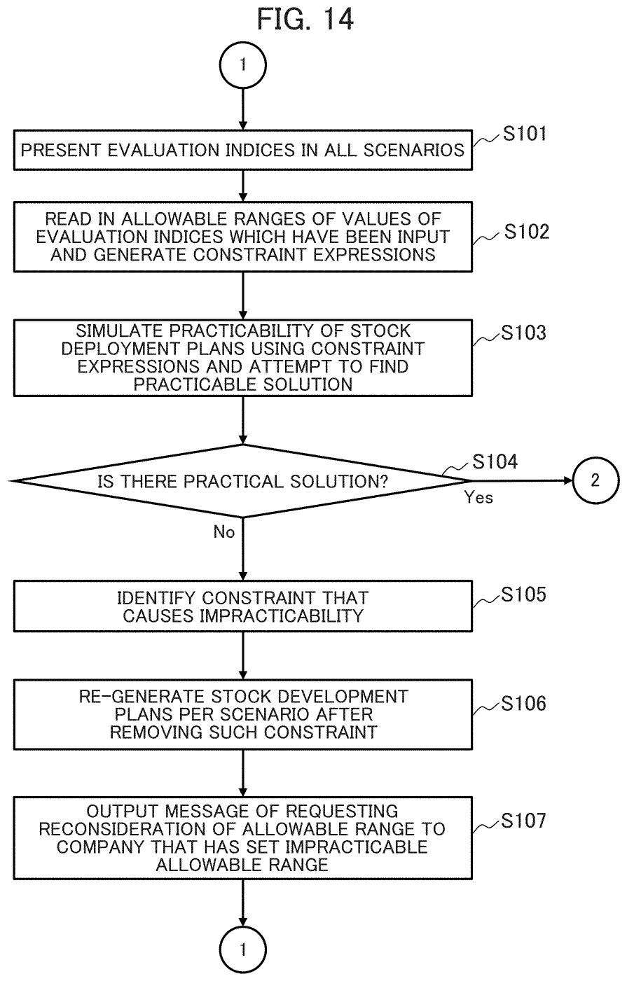

FIG. 13 and FIG. 14 are diagrams illustrating an example of a flow of a process to generate stock planning. The process to generate stock planning starts when the decision support device 100 accepts a start command from a user via an interface device.

First, the scenario generating unit 131 reads in information on a supply chain, demand, and stock (step S001). Specifically, the scenario generating unit 131 reads in company information 111, production information 112, transportation information 113, demand information 114, and stock information 115.

Then, the prioritizing of indices accepting unit 140 accepts input of ordering of prioritizing the evaluation indices from the participating companies (step S002). In particular, the prioritizing of indices accepting unit 140 accepts input of ordering of prioritizing each of the evaluation indices sent from the user terminals 200 of the participating companies constituting the supply chain and it stores such ordering as evaluation index prioritizing information 16.

Then, the objective function generating unit 138 generates objective functions for computing optimization per scenario using the ordering of prioritizing the evaluation indices that each participating company has set (step S003). In particular, the scenario generating unit 131 generates a scenario 1 giving priority to the evaluation indices of the entire supply chain and scenarios 2 to N+1 giving priority to the evaluation indices of any of N participating companies. Then, the objective function generating unit 138 generates an objective function of the forgoing formula (1) for the scenario 1. For the scenarios 2 to N+1, the objective function generating unit 138 weights the evaluation indices for each of N participating companies according to order of prioritizing the evaluation indices sent by each of them and generates objective functions, following the example of the foregoing formula (4) or formula (3), respectively.

Then, the stock deployment plan generating unit 132 generates stock deployment plans per scenario and identifies a scenario 1 that becomes optimal throughout the supply chain as an optimal scenario (step S004). In particular, the stock deployment plan generating unit 132 generates stock deployment plans per scenario and stores them as stock deployment plan information 117 and, besides, identifies a scenario that becomes optimal throughout the supply chain as an optimal scenario, namely, the scenario 1.

Then, the stock planning settling unit 139 displays the stock deployment plan and the values of the evaluation indices in the optimal scenario (step S005). Specifically, with regard to the stock deployment plans generated by the stock deployment plan generating unit 132, the stock planning settling unit 139 computes the evaluation indices with respect to each of the participating companies constituting the supply chain and stores results as evaluation index information 118. Then, the stock planning settling unit 139 generates screen information for displaying the stock deployment plan of the optimal scenario and its related evaluation indices and accepting input specifying whether or not each participant agrees to the stock deployment plan and displays such screen information on the user terminals 200.

Then, the stock planning settling unit 139 accepts input of confirmation and agreement from all the participating companies (step S006). In particular, the stock planning settling unit 139 accepts input specifying agreement or disagreement to the stock deployment plan of the scenario 1, sent from each of the participating companies constituting the supply chain within a certain time limit (e.g., within three business days).

The stock planning settling unit 139 decides whether all the participating companies have agreed to the stock deployment plan (step S007). In particular, the stock planning settling unit 139 decides that all the participating companies have agree to the stock deployment plan, unless input specifying disagreement has sent from one or more participating companies within the time limit of accepting input of agreement/disagreement. If the participants have agreed (“Yes” at step S007), the stock planning settling unit 139 adopts the stock deployment plan to which they agreed and exits the process to generate stock planning.

If no agreement has been made (“No” at step S007), to participating companies other than those that agreed, the discrete scenario result displaying unit 133 presents the computed values of the evaluation indices for such companies in all scenarios and accepts input of allowable ranges of values of the evaluation indices (S101). The reason of presenting the values of the evaluation indices in all scenarios is allowing participants prompted for input to see through a level of values of the evaluation indices across all scenarios and set an appropriate allowable range. For instance, supposing that the values of the demand fulfillment rate in any scenario are on a certain level (e.g., below 80%), setting of an allowable range that is far from the level (95% or above) is an action that makes it quite hard to realize optimization throughout the supply chain. It is a shortcut way to realization that participating companies understand the level.

Then, the allowable range constraints creating unit 134 reads in allowable ranges of values of the evaluation indices which have been input and generates constraint expressions (step S102). In particular, the allowable range constraints creating unit 134 stores the input allowable ranges of values of the evaluation indices as allowable range information 119 and then formulates them and creates constraints as expressed in the foregoing formula (2).

The unit for attempting to modify stock deployment plans 135 simulates practicability of stock deployment plans and attempts to find a practicable solution (step S103). Namely, the unit for attempting to modify stock deployment plans 135 restricts the stock deployment plans that are practicable in terms of resources of the supply chain to the allowable ranges specified by the participating companies and finds a solution among them.

Then, the unit for attempting to modify stock deployment plans 135 decides whether or not there is a practicable solution (step S104). If there is a practicable solution (“Yes” at step S104), the unit for attempting to modify stock deployment plans 135 returns control to step S004 and executes re-generating stock deployment plans under constraint conditions.

If there is not a practicable solution (“No” at step S104), the unit for attempting to modify stock deployment plans 135 moves control to step S105.

Then, the unit for identifying a constraint causing impracticability identifies a constraint that causes impracticability (Step S105). In particular, the unit for identifying a constraint causing impracticability identifies a constraint that causes impracticability by a certain well-known algorithm, identifies a participating company that has set the constraint, and stores them as impracticable constraint information 120.

Then, the unit for attempting to modify stock deployment plans 135 re-generates stock deployment plans per scenario after removing the constraint that causes impracticability (step S106). In particular, using the constraint expressions from which a constraint causing impracticability was removed, this unit simulates practicability of stock deployment plans and attempts to find a practicable solution, thus identifying what constraint causing impracticability should be removed so that a practicable solution can be obtained.

Then, the unit for requesting reconsideration of allowable range 137 outputs a message of requesting reconsideration of allowable range to a company that has set an impracticable allowable range (step S107). In particular, to a company that has set the constraint causing impracticability that should be removed so that a practicable solution can be obtained, the unit for requesting reconsideration of allowable range 137 presents the computed values of the evaluation indices put under the constraint causing impracticability and outputs a message of requesting reconsideration of the allowable range. Then, the unit for requesting reconsideration of allowable range 137 returns control to step S101.

The above is the example of the flow of the process to generate stock planning. According to the process to generate stock planning, it is possible to support decision making in doing stock planning.

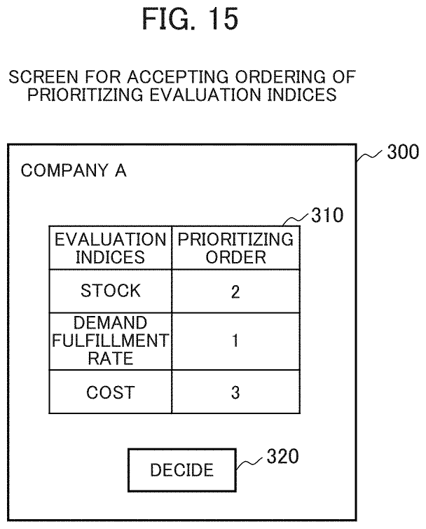

FIG. 15 is a diagram illustrating an example of a screen for accepting ordering of prioritizing the evaluation indices. The example of the screen 300 for accepting ordering of prioritizing is generated in the step S002 of the process to generate stock planning and displayed on the user terminal 200 and this screen can accept input of ordering of prioritizing each of the evaluation indices specified by each participating company. The example of the screen 300 for accepting ordering of prioritizing includes an input table 310 for ordering of prioritizing the evaluation indices and a decide button 320. The input table 310 for ordering of prioritizing the evaluation indices accepts input of information of ordering of prioritizing each of the evaluation indices. When the decide button 320 is entered, information of ordering of prioritizing entered to the input table 310 for ordering of prioritizing the evaluation indices is read out and sent to the decision support device 100.

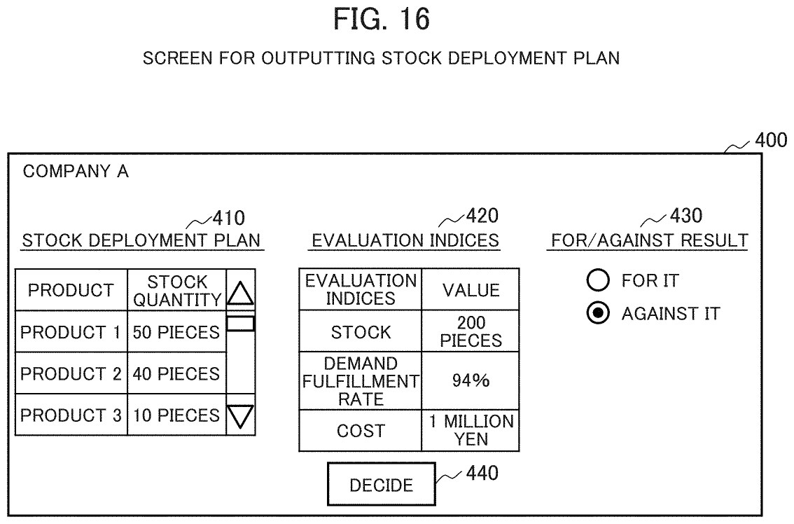

FIG. 16 is a diagram illustrating an example of a screen for outputting a stock deployment plan. The example of the screen 400 for outputting a stock deployment plan is generated in the step S005 of the process to generate stock planning and displayed on the user terminal 200 and this screen includes the sections of stock deployment plan 410, evaluation indices 420, and for/against result 430, and a decide button 440. In the section of stock deployment plan 410, a stock deployment plan that, for example, lists stock quantities per product among others is displayed. In the section of evaluation indices 420, the values of the evaluation indices for the stock deployment plan, such as, e.g., stock, demand fulfillment rate, and cost are displayed. The section of for/against result 430 accepts input specifying that the participant is for/against (agrees or disagrees to) the stock deployment plan. When the decide button 440 is entered, agreement or disagreement information which has been input to the section of for/against result 430 is read out and sent to the decision support device 100.

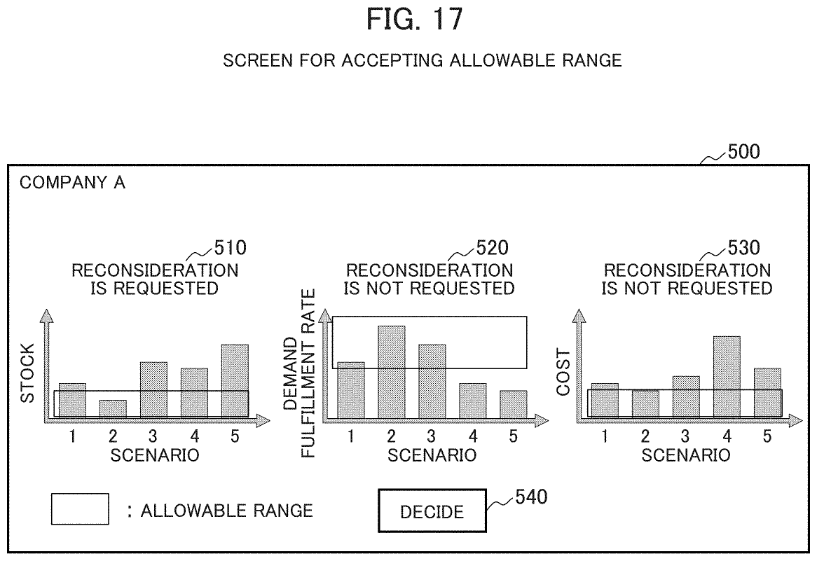

FIG. 17 is a diagram illustrating an example of a screen for accepting allowable ranges. The example of the screen 500 for accepting allowable ranges is generated in the step S101 of the process to generate stock planning and displayed on the user terminal 200 and this screen displays graphs per evaluation index, each graph plotting the values of each of the evaluation indices for all scenarios. Also, this screen accepts input of upper and lower limit values that define an allowable range (input as a rectangular region in each graph). Specifically, the example of the screen 500 for accepting allowable ranges includes a stock graph 510 in which the ordinate is stock and the abscissa is scenario, a demand fulfillment rate graph 520 in which the ordinate is demand fulfillment rate and the abscissa is scenario, a cost graph 530 in which the ordinate is cost and the abscissa is scenario, and a decide button 540.

Included in each of the stock graph 510, the demand fulfillment rate graph 520, and the cost graph 530, there is an attached note saying whether or not reconsideration is requested, which indicates whether or not the graph corresponds to a constraint for which a request is made to reconsider the allowable range of values of each index (i.e., a constraint that causes impracticability).

When the decide button 540 is entered, the input allowable ranges in each of the stock graph 510, the demand fulfillment rate graph 530, and the cost graph 530 are read out and sent to the decision support device 100.

The foregoing has described the configuration of the decision support system 1 relevant to the embodiment. According to the decision support system 1, it is possible to support decision making in doing stock planning.

Note that the present invention is not limited to the embodiment described hereinbefore and various modifications are included therein. The foregoing embodiment is that described in detail to explain the present invention to make it easy to understand and the invention is not necessarily limited to that including all components described. A subset of the components of the embodiment may be replaced by other components. Besides, a subset of the components of the embodiment may be removed.

Besides, a subset or all of the aforementioned units, components, functions, processing units, etc. may be implemented by hardware; for example, inter alia, by designing an integrated circuit to implement them. Also, the aforementioned units, components, functions, etc. may be implemented by software in such a way that a processor interprets and executes programs that implement the respective functions. Information such as programs that implement the respective functions, tables, and files may be placed in a recording device such as a memory or a hard disk or a recording medium such as an IC card, an SD card, or a DVD.

Besides, as for control lines and information lines concerned in the foregoing embodiment, those considered as necessary for explanation are delineated and all control lines and information lines involved in a product are not necessarily delineated.

Actually, almost all components may be considered to be interconnected. The foregoing has described the present invention, focusing on its embodiment.

What is claimed is:

1. A decision support device comprising:
a stock deployment plan generating unit which generates a stock deployment plan that becomes optimal throughout a supply chain;
an allowable range constraints creating unit which, from multiple participating companies that constitute the supply chain, accepts input of allowable ranges of values of evaluation indices for a set of stock deployment plans, sent by each of the participating companies, and generates constraint information;
a unit for attempting to modify stock deployment plans which attempts to modify the stock deployment plans using the constraint information;
a unit for identifying a constraint causing impracticability which identifies constraint information that causes impracticability, if the unit for attempting to modify stock deployment plans fails to obtain a practicable solution; and
a unit for requesting reconsideration of allowable range which requests a participating company that has set the constraint information that causes impracticability to input the allowable ranges again.

2. The decision support device according to claim 1, wherein:
a decision is made as to whether a stock deployment plan is optical throughout the supply chain using a certain objective function; and
the decision support device further comprises an objective function generating unit which generates an objective function according to order of prioritizing of the evaluation indices with respect to each of the participating companies.

3. The decision support device according to claim 1, wherein:
a decision is made as to whether a stock deployment plan is optical throughout the supply chain using a certain objective function; and
the decision support device further comprises:
an objective function generating unit which generates an objective function according to order of prioritizing of the evaluation indices with respect to each of the participating companies; and
a prioritizing of indices accepting unit which accepts input of prioritizing of the evaluation indices, sent by each of the participating companies.

4. The decision support device according to claim 1, wherein:
in addition to generating a stock deployment plan that becomes optimal throughout the supply chain, the stock deployment plan generating unit generates stock deployment plans according to a scenario in which priority is given to the evaluation indices of any one or plurality of the participating companies.

5. The decision support device according to claim 1, wherein:
in addition to generating a stock deployment plan that becomes optimal throughout the supply chain, the stock deployment plan generating unit generates stock deployment plans according to a scenario in which priority is given to the evaluation indices of any one or plurality of the participating companies; and
the unit for requesting reconsideration of allowable range, when making a request for re-input of an allowable range, displays the evaluation indices per scenario with respect to each of the participating companies concerned.

6. The decision support device according to claim 1, wherein:
when the constraint information causing that a practicable solution cannot be obtained is attributed to contradiction between values of constraints specified as constraint information, the unit for requesting reconsideration of allowable range, when making a request for re-input of an allowable range, issues the re-input request to a participating company that has set the constraint information that should be removed so that the practicable solution can be obtained, the constraint information corresponding to any of the contradictory values of constraints.

7. The decision support device according to claim 1, wherein:
the allowable range constraints creating unit generates screen information for accepting input of allowable ranges of values of evaluation indices for a set of stock deployment plans, sent by each of the multiple participating companies constituting the supply chain.

8. The decision support device according to claim 1, further comprising:
a stock planning settling unit which computes the evaluation indices for a stock deployment plan generated by the stock deployment plan generating unit with respect to each of the participating companies constituting the supply chain, generates screen information for presenting the stock deployment plan and the evaluation indices and accepting input as to whether or not each participant agrees to the stock deployment plan, determines whether agreement from the participating companies is settled, and adopts the stock deployment plan, if agreed, as stock planning.

9. A decision support system comprising:
a stock deployment plan generating unit which generates a stock deployment plan that becomes optimal throughout a supply chain;
an allowable range constraints creating unit which, from multiple participating companies that constitute the supply chain, accepts input of allowable ranges of values of evaluation indices for a set of stock deployment plans, sent by each of the participating companies, and generates constraint information;
a unit for attempting to modify stock deployment plans which attempts to modify the stock deployment plans using the constraint information;
a unit for identifying a constraint causing impracticability which identifies constraint information that causes impracticability, if the unit for attempting to modify stock deployment plans fails to obtain a practicable solution; and
a unit for requesting reconsideration of allowable range which requests a participating company that has set the constraint information that causes impracticability to input the allowable ranges again.

10. A decision support method comprising:
a stock deployment plan generating step which generates a stock deployment plan that becomes optimal throughout a supply chain;
an allowable range constraints creating step which, from multiple participating companies that constitute the supply chain, accepts input of allowable ranges of values of evaluation indices for a set of stock deployment plans, sent by each of the participating companies, and generates constraint information;
a step for attempting to modify stock deployment plans which attempts to modify the stock deployment plans using the constraint information;
a step for identifying a constraint causing impracticability which identifies constraint information that causes impracticability, if the step for attempting to modify stock deployment plans fails to obtain a practicable solution; and
a step for requesting reconsideration of allowable range which requests a participating company that has set the constraint information that causes impracticability to input the allowable ranges again.
